(19) United States
(12) Patent Application Publication
(10) Pub. No.: US 2023/0286698 A1
(43) Pub. Date: Sep. 14, 2023

(54) Reusable Shipping And Storage Package Including Collapsible Features

(71) Applicant: Terumo BCT, Inc., Lakewood, CO (US)

(72) Inventor: Brian F. ESTEY, Littleton, CO (US)

(21) Appl. No.: 18/171,467

(22) Filed: Feb. 20, 2023

Related U.S. Application Data
(60) Provisional application No. 63/319,652, filed on Mar. 14, 2022.

(51) Int. Cl. B65D 21/08; B65D 65/38; B65D 5/50; B65D 5/468; B65D 5/68

(52) U.S. Cl. CPC B65D 21/086; B65D 65/38; B65D 5/5088; B65D 5/4608; B65D 5/68; B65D 2565/384; B65D 2565/385

(57) ABSTRACT

A reusable package is capable of being arranged in an expanded or device transport, state and a compact, or storage, state. In the compact state, the reusable package takes up less than half of the volume or space of the reusable package in the expanded state. The reusable package includes a base, a lid, and a sidewall support structure that is disposed between the base and the lid. The sidewall support structure has four sidewalls joined together in a rectangular shape. At least two of the sidewalls may have creases arranged along a height of the sidewalls. The sidewall support structure is collapsible at the creases when moved into the compact state.

### CROSS REFERENCE TO RELATED APPLICATIONS

This application claims priority to U.S. Application No. 63/319,652 filed Mar. 14, 2022, which is expressly incorporated by reference herein in its entirety.

### BACKGROUND

The present disclosure is generally directed to packaging, in particular, toward recycled and reusable packaging for products and devices.

Product packaging for shipping and/or storage is usually made from one or more materials such as plastic, cardboard, corrugated cardboard/fiberboard, and/or the like. Larger devices are usually transported in wood or large corrugated packaging. In any event, once a product or device is shipped, the large packaging may be stored or broken down for recycling/disposal.

### BRIEF SUMMARY

After a product or device is removed from large packaging (e.g., that may be used for transportation or shipping, etc.), the large packaging must be stored or otherwise processed. In some cases, a user may wish to store the large packaging in case the product or device needs to be returned to the manufacturer for repair, refurbishment, and/or upgrades. Additionally or alternatively, the user may want to store the large packaging in case the product or device needs to be transported from one location to another. In any event, storing large packaging requires taking up valuable space in a facility, building, room, or location.

In some cases, for example, when a user does not wish to store the large packaging, the large packaging may be broken down for recycling and/or other use. Breaking down large packaging generally requires that a user and/or machine cut, tear, or otherwise break the material of the large packaging into smaller pieces so that the smaller pieces can be bundled together in a flat package for recycling. As can be appreciated, this breaking down of large packaging can be labor intensive, time intensive, and typically does not allow the large packaging to be reused.

It is with respect to the above issues and other problems that the embodiments presented herein were contemplated. Among other things, the present disclosure provides a reusable package that is capable of being arranged in an expanded (e.g., device transport, etc.) state and a compact (e.g., storage, reuse, etc.) state. In the compact state, the reusable package may take up less than half of the volume (e.g., space, etc.) of the reusable package in the expanded state. In some examples, the reusable package may take up less than one quarter of the volume (e.g., space, etc.) of the reusable package in the expanded state. In one example, the reusable package may take up less than one eighth, or less, of the volume (e.g., space, etc.) of the reusable package in the expanded state.

The reusable package described herein may include a base, a lid, and a sidewall support structure disposed between the base and the lid. The sidewall support structure may have a height that defines a distance between the base and the lid in the expanded state. In some examples, the sidewall support structure may comprise four sidewalls joined together in a rectangular shape. At least two of the sidewalls may have creases arranged along the height between width sides of the sidewalls. While these creases may be arranged such that they provide structural integrity to the reusable package in the expanded state, the sidewall support structure may be collapsed at these creases when moved into the compact state. When in the collapsed state, the sidewall support structure may be inserted into the base and the lid and base may be arranged in contact with one another containing the sidewall support structure therebetween.

The preceding is a simplified summary of the disclosure to provide an understanding of some aspects of the disclosure. This summary is neither an extensive nor exhaustive overview of the disclosure and its various aspects, embodiments, and configurations. It is intended neither to identify key or critical elements of the disclosure nor to delineate the scope of the disclosure but to present selected concepts of the disclosure in a simplified form as an introduction to the more detailed description presented below. As will be appreciated, other aspects, embodiments, and configurations of the disclosure are possible utilizing, alone or in combination, one or more of the features set forth above or described in detail below.

Numerous additional features and advantages are described herein and will be apparent to those skilled in the art upon consideration of the following Detailed Description and in view of the figures.

### BRIEF DESCRIPTION OF THE SEVERAL VIEWS OF THE DRAWINGS

The accompanying drawings are incorporated into and form a part of the specification to illustrate several examples of the present disclosure. These drawings, together with the description, explain the principles of the disclosure. The drawings simply illustrate preferred and alternative examples of how the disclosure can be made and used and are not to be construed as limiting the disclosure to only the illustrated and described examples. Further features and advantages will become apparent from the following, more detailed, description of the various aspects, embodiments, and configurations of the disclosure, as illustrated by the drawings referenced below.

FIG. 1A shows a perspective view of a reusable package in accordance with embodiments of the present disclosure;

FIG. 1B shows an exploded perspective view of the reusable package in accordance with embodiments of the present disclosure;

FIG. 1C shows a perspective view of the reusable package with the lid removed in accordance with embodiments of the present disclosure;

FIG. 1D shows a perspective view of the base of the reusable package in accordance with embodiments of the present disclosure;

FIG. 1E shows a perspective view of a sidewall support structure of the reusable package in accordance with embodiments of the present disclosure;

FIG. 2A shows a perspective view of the base of the reusable package with inserts disposed therein in accordance with embodiments of the present disclosure;

FIG. 2B shows a reusable package in a compact state in accordance with embodiments of the present disclosure;

FIG. 3A shows a schematic perspective view of an expanded state of multiple reusable packages stacked adjacent one another for in accordance with embodiments of the present disclosure; and

FIG. 3B shows a schematic perspective view of a compact state of multiple reusable packages stacked adjacent one another in accordance with embodiments of the present disclosure.

### DETAILED DESCRIPTION

Before any embodiments of the disclosure are explained in detail, it is to be understood that the disclosure is not limited in its application to the details of construction and the arrangement of components set forth in the following description or illustrated in the drawings. The disclosure is capable of other embodiments and of being practiced or of being carried out in various ways. Also, it is to be understood that the phraseology and terminology used herein is for the purpose of description and should not be regarded as limiting. The use of “including,” “comprising,” or “having” and variations thereof herein is meant to encompass the items listed thereafter and equivalents thereof as well as additional items. Further, the present disclosure may use examples to illustrate one or more aspects thereof. Unless explicitly stated otherwise, the use or listing of one or more examples (which may be denoted by “for example,” “by way of example,” “e.g.,” “such as,” or similar language) is not intended to and does not limit the scope of the present disclosure.

The ensuing description provides embodiments only, and is not intended to limit the scope, applicability, or configuration of the claims. Rather, the ensuing description will provide those skilled in the art with an enabling description for implementing the described embodiments. It being understood that various changes may be made in the function and arrangement of elements without departing from the spirit and scope of the appended claims.

Various aspects of the present disclosure will be described herein with reference to drawings that may be schematic illustrations of idealized configurations.

As described above, storing conventional large packaging requires taking up valuable space in a facility, building, room, or location. Additionally or alternatively, breaking down large packaging can be labor intensive, time intensive, and typically does not allow the large packaging to be reused.

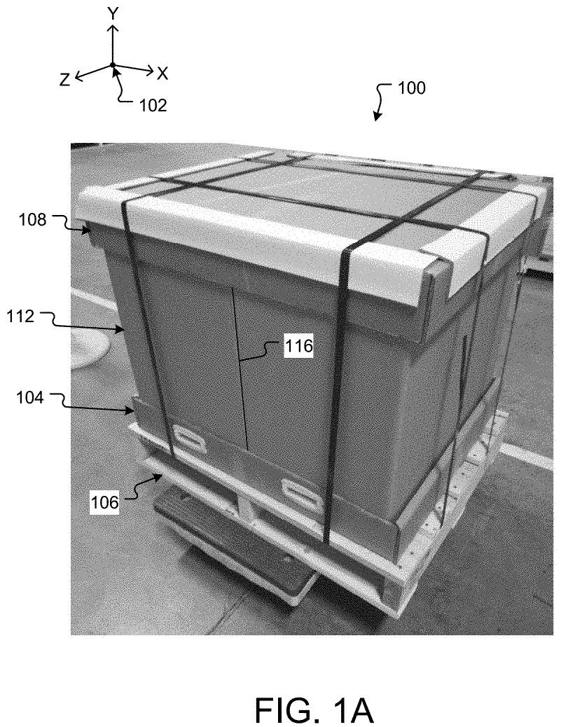

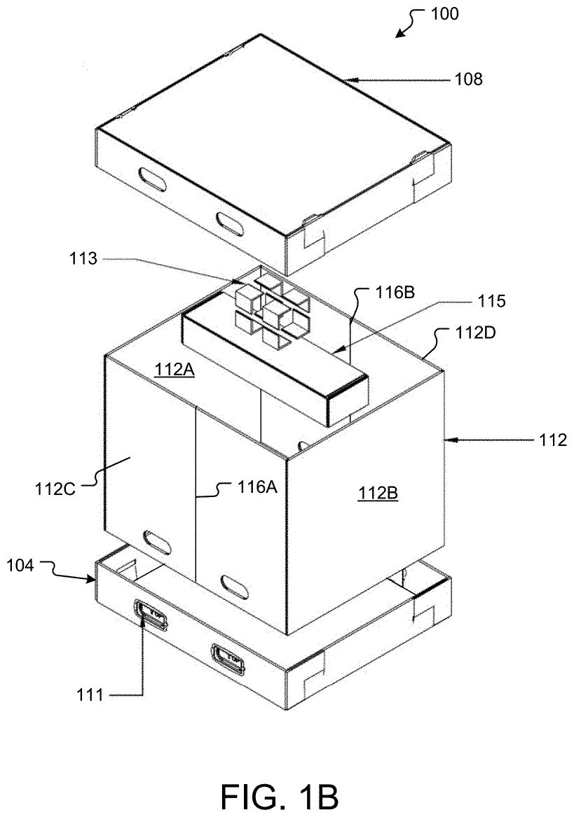

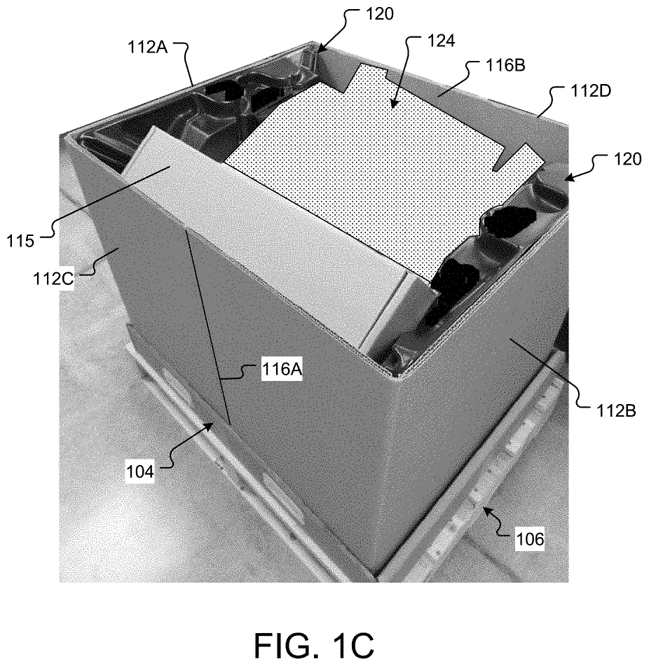

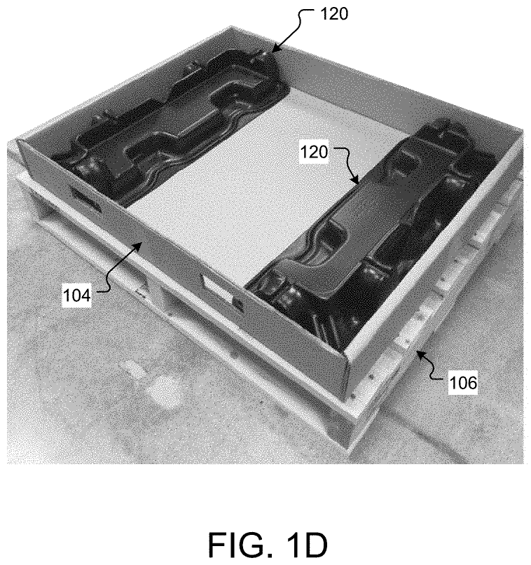

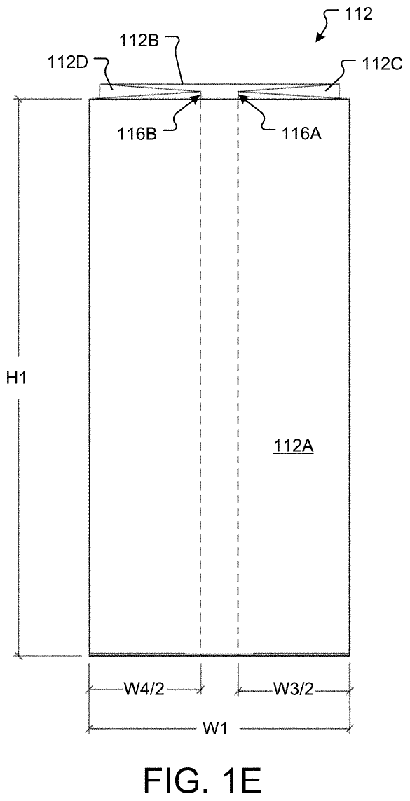

It is with respect to at least the above issues and other problems that the embodiments presented herein were contemplated. Among other things, the reusable package 100 described herein may provide a recycled and recyclable package that is environmentally responsible, ecologically sustainable, and that is able to be reused multiple times. FIGS. 1A-1E show various views of a reusable package 100 in accordance with examples of the present disclosure. The reusable package 100 may comprise a base 104, a lid 108, and a sidewall support structure 112. In some examples, the sidewall support structure 112 may be disposed between the base 104 and the lid 108. The sidewall support structure 112 may be made from a plurality of panels 112A-112D joined or formed together. The reusable package 100 may be configured to receive and/or contain a product, device, or plurality thereof. For instance, a product 124 (shown in FIG. 1C) may be held, or contained, inside the reusable package 100.

In some examples, the reusable package 100 may be loaded onto a pallet 106. The pallet 106 may provide a sturdy base support structure for stacking multiple reusable packages 100 (e.g., during shipping, storage, or transport, etc.). However, it should be appreciated that the base 104 may be structured such that the reusable package 100 may contain and/or support a product 124 during handling. In some examples, the reusable package 100 may comprise a number of handles 111 disposed around a periphery of the base 104 and/or the lid 108. In one example, the handles 111 may interconnect with the sidewall support structure 112. In addition to joining the base 104 to the sidewall support structure 112, the thickness of at least one of the panels 112A-112D of the sidewall support structure 112 and the thickness of the base (e.g., through which the handles 111 pass), may provide additional strength when lifting or moving the reusable package 100.

Referring now to FIG. 1A, a perspective view of a reusable package 100 is shown in accordance with examples of the present disclosure. Features of the reusable package 100 may be described in conjunction with a coordinate system 102. The coordinate system 102, as shown in the figures, includes three-dimensions comprising an X-axis, a Y-axis, and a Z-axis. Additionally or alternatively, the coordinate system 102 may be used to define planes (e.g., the XY-plane, the XZ-plane, and the YZ-plane) of the reusable package 100. These planes may be disposed orthogonal, or at 90 degrees, to one another. While the origin of the coordinate system 102 may be placed at any point on or near the components of the reusable package 100, for the purposes of description, the axes of the coordinate system 102 are always disposed along the same directions from figure to figure. In some examples, reference may be made to dimensions, angles, directions, relative positions, and/or movements associated with one or more components of the reusable package 100 with respect to the coordinate system 102. For example, an overall width of the reusable package 100 may be defined as a dimension along the X-axis of the coordinate system 102, the height of the reusable package 100 may be defined as dimension along the Y-axis of the coordinate system 102, and the length, or depth, of the reusable package 100 may be defined as a dimension along the Z-axis of the coordinate system 102.

In some examples, the width of the first panel 112A (e.g., as shown in FIG. 1B, etc.) may be defined as a dimension along the Z-axis and a height of the first panel 112A may be defined as a dimension along the Y-axis. Similarly, the width of the second panel 112B may be defined as a dimension along the Z-axis and a height of the second panel 112B may be defined as a dimension along the Y-axis. In some examples, these panels 112A-112B may be parallel to, and offset from, one another. In one example, the width of the third panel 112C may be defined as a dimension along the X-axis and a height of the third panel 112C may be defined as a dimension along the Y-axis. Additionally or alternatively, the width of the fourth panel 112D may be defined as a dimension along the X-axis and a height of the fourth panel 112D may be defined as a dimension along the Y-axis. The third panel 112C and the fourth panel 112D may be arranged parallel to, and offset from, one another in the expanded state of the reusable package 100 shown in FIGS. 1A-1C. As can be appreciated, the first and second panels 112A-112B may be arranged perpendicular to the third and fourth panels 112C-112D of the sidewall support structure 112.

In FIG. 1A, the reusable package 100 is shown mounted to a pallet 106 and fastened thereto by a plurality of straps. The straps may be plastic, fabric, composite, steel, combinations thereof and/or the like. In some examples, the expanded state of the reusable package 100 shown in FIG. 1A may correspond to a “shipping” state. In some examples, one or more corner or edge guards may be disposed between the reusable package 100 and the straps. These corner or edge guards are shown as L-shaped lengths of cardboard/fiberboard along the top edges of the periphery of the lid 108 in FIG. 1A.

FIG. 1B shows an exploded perspective view of the reusable package 100 in accordance with examples of the present disclosure. In some examples, the sidewall support structure 112 may be disposed within a periphery of the base 104 and/or the lid 108. For instance, the lower edges of the sidewall support structure 112 may be disposed within raised sidewalls of the base 104 and/or the lid 108. In some examples, the reusable package 100 may be configured to receive at least one insert 115, product 124, and/or thermoformed insert 120, as shown in FIG. 1C. The reusable package 100 may include corner guards 113 placed at the corners of the base 104 and/or the lid 108.

As shown in FIG. 1B, the sidewall support structure 112 may include fold creases 116 arranged in the third panel 112C and the fourth panel 112D. The third panel 112C may oppose the fourth panel 112D. The fold creases 116 may include a first fold crease 116A disposed along a height direction of the third panel 112C and a second fold crease 116B disposed along a height direction of the fourth panel 112D. The fold creases 116 may correspond to a crimped, or weakened, area of the third panel 112C and the fourth panel 112D of the sidewall support structure 112. In some examples, the first fold crease 116A may be formed by compressing the third panel 112C along a line disposed between a first width edge of the third panel 112C and a second width edge of the third panel 112C. Additionally or alternatively, the second fold crease 116B may be formed by compressing the fourth panel 112D along a line disposed between a first width edge of the fourth panel 112D and a second width edge of the third panel 112D. In some examples, the lines where the fold creases 116 are formed may be arranged at a width center of a respective panel 112C, 112D. The fold creases 116 may run along a section of the height of the respective panel 112C, 112D. In one example, the fold creases 116 may run along an entirety of the height of the respective panel 112C, 112D. In any event, the fold creases 116 may form a living hinge for the third panel 112C and/or the fourth panel 112D to bend about (e.g., when moving from an unfolded state, as shown in FIGS. 1A-1C to a folded state, as shown in FIG. 1E, etc.).

FIG. 1C shows a perspective view of the reusable package 100, in an expanded state (e.g., where the sidewall support structure 112 is in an unfolded state) with the lid 108 removed in accordance with examples of the present disclosure. In some examples, the product 124 may be held inside the reusable package 100 via one or more thermoformed inserts 120 and/or other inserts 115. In one example, the sidewall support structure 112 may be held in the unfolded state via a force of the product 124 and the thermoformed inserts 120 pushing on the first panel 112A and the second panel 112B. Additionally or alternatively, the sidewall support structure 112 may be held in the unfolded state by the structure of the product 124 and the thermoformed inserts 120 contacting the first panel 112A and the second panel 112B and preventing movement of the first panel 112A toward the second panel 112B and/or vice versa.

In some examples, the thermoformed inserts 120 may be made from post-consumer recycled materials. For instance, the thermoformed inserts 120 may be made from 100% recycled high-density polyethylene (HDPE) or the like. The thermoformed inserts 120 may be opaque and colored, or died, black, dark grey, or other dark color to avoid bleaching or other treatment of the recycled material. In addition to being aesthetically pleasing, this coloring ensures that the materials making up the reusable package 100 are ecologically sustainable.

FIG. 1D shows a perspective view of the base of the reusable package 100 in accordance with examples of the present disclosure. In some examples, the thermoformed inserts 120 may be coupled with the base 104 and/or the lid 108. In one example, the thermoformed inserts 120 may be removable from the base 104 and the coupling may correspond to a press, or interference, fit between the thermoformed inserts 120 and at least a portion of the base 104 and/or the lid 108. Additionally or alternatively, the thermoformed inserts 120 may be glued, taped, or otherwise adhered to the base 104 and/or the lid 108. In any event, the thermoformed inserts 120 may be separated from the reusable package 100 for recycling. Stated another way, the thermoformed inserts 120 may not only be made of recycled material but may also be recyclable. This feature, among other things, adds to the environmentally conscious packaging of the reusable package 100.

The base 104, the lid 108, and/or the sidewall support structure 112 may be made from a recycled material and/or a recyclable material. In some examples, the base 104, the lid 108, and/or the sidewall support structure 112 may be made from recycled cardboard, corrugated material, fiberboard, and/or the like. In any event, the reusable package 100 may be made from 100% recycled and/or recyclable (e.g., capable of being recycled, etc.) materials.

FIG. 1E shows a perspective view of the sidewall support structure 112 of the reusable package 100 in a folded state in accordance with examples of the present disclosure. The sidewall support structure 112 may comprise a first panel 112A having a first width, W1, and a first height, H1. The first width, W1, may extend from a first width side to a second width side of the first panel 112A. The first height, H1, may extend from a lower edge side (e.g., at the lower portion of the page of FIG. 1E) to an upper edge side (e.g., at the upper portion of the page of FIG. 1E). In some examples, each of the panels 112A-112D may extend a height that is equal, or substantially equal (e.g., plus or minus half an inch, etc.), to the first height, H1. In one example, the width of each of the panels 112A-112D may correspond to the first width, W1, shown in FIG. 1E. In this example, the rectangular shape of the sidewall support structure 112 in the unfolded state may correspond to a square shape (e.g., when viewed from the top, or normal to the XZ-plane). Alternatively, the widths of the third panel 112C and the fourth panel 112D may be greater than or less than the first width, W1, shown in FIG. 1E. When in the folded state, the width, W3, of the third panel 112C may be divided by two at the first fold crease 116A, and the width, W4, of the fourth panel 112D may be divided by two at the second fold crease 116B. In any event, the first fold crease 116A may be disposed adjacent the second fold crease 116B in the folded state of the sidewall support structure 112.

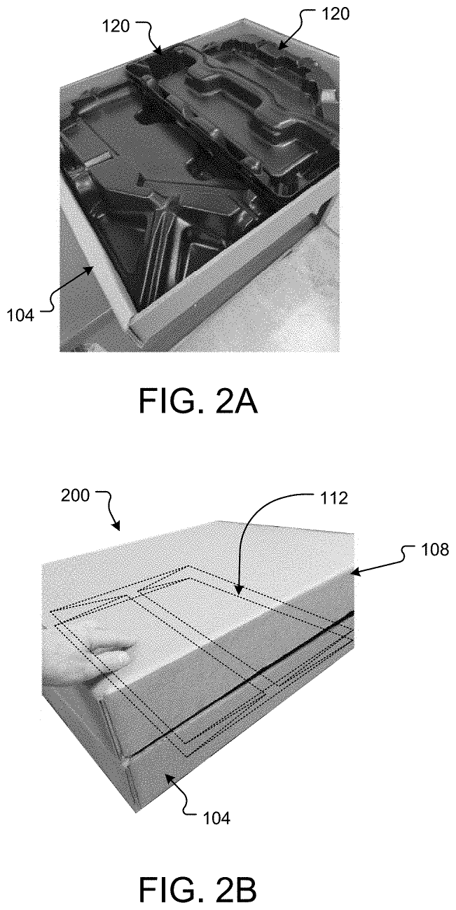

In FIG. 1E, the third panel 112C and the fourth panel 112D have been bent at their respective fold creases 116A, 116B such that the fold creases 116A, 116B are moved from an outer periphery of the base 104 (not shown) to a center of the base 104 (not shown). In this folded state, the first fold crease 116A is disposed adjacent the second fold crease 116B. Further, the first fold crease 116A and the second fold crease 116B are each disposed between the first panel 112A and the second panel 112B. In some examples, the first panel 112A and the second panel 112B may be brought closer to one another in the folded state shown in FIG. 1E than in the unfolded state shown in the expanded state of the reusable package 100 in FIGS. 1A-1C. When the sidewall support structure 112 is arranged in the folded state shown in FIG. 1E, the sidewall support structure 112 may fit within the area of the base 104 and/or the lid 108. In one example, the sidewall support structure 112 may fit completely within the periphery of the base 104 and in a space between the base 104 and the lid 108 when the lid 108 is brought into contact with the base 104 (e.g., as shown in FIG. 2B). In some examples, the reusable package 100, in the folded state, may be laid inside the base 104 such that the first panel 112A or the second panel 112B is parallel to the base 104 (e.g., the planar panel or portion forming the lower portion of the base 104 in the XZ-plane, etc.). When in this position, the other of the first panel 112A or the second panel 112B may be arranged parallel to the lid 108 (e.g., the planar panel or portion forming the upper portion of the lid 108 in the XZ-plane, etc.).

FIGS. 2A-2B show various perspective views of the reusable package 100 transitioning into the compact state (e.g., into the compact package 200) in accordance with examples of the present disclosure. As described herein, the reusable package 100 may be shipped to and/or from a facility as a compact package 200. The compact package 200 may have an overall volume that is at least half of the volume of the reusable package 100 in the expanded state. As can be appreciated, this reduced volume allows the compact package 200 to be stored and/or transported without taking up unnecessary space.

Referring now to FIG. 2A, a perspective view of the base 104 of the reusable package 100 with one or more thermoformed inserts 120 disposed therein in accordance with examples of the present disclosure. As shown in FIG. 2A, the base 104 may be sized to receive one, or all, of the thermoformed inserts 120 used in the reusable package 100. The thermoformed inserts 120 may be stacked inside the base 104 and arranged such that the thermoformed inserts 120 are within the periphery of the base 104. In some examples, the sidewall support structure 112 may be inserted in the base 104 in the folded state. For instance, the folded sidewall support structure 112 may be inserted in the base 104 beneath the thermoformed inserts 120 placed therein or laid on top of the thermoformed inserts 120 in the base 104 (as shown by the sidewall support structure 112, in dashed lines, of FIG. 2B).

In FIG. 2B, the lid 108 is brought into contact with the base 104 forming the compact package 200. In some examples, the outer periphery of the base 104 may match the outer periphery of the lid 108. When the lid 108 is brought into contact with the base 104, the thermoformed inserts 120 and the folded sidewall support structure 112 may be entirely contained therebetween and within an area of the base 104 and/or the lid 108. As provided above, the compact package 200 may have an overall volume that is less than half of the volume of the reusable package 100 when in the expanded state shown in FIGS. 1A-1C. Stated another way, the compact package 200 takes up less than half of the space than the reusable package 100 in the expanded state.

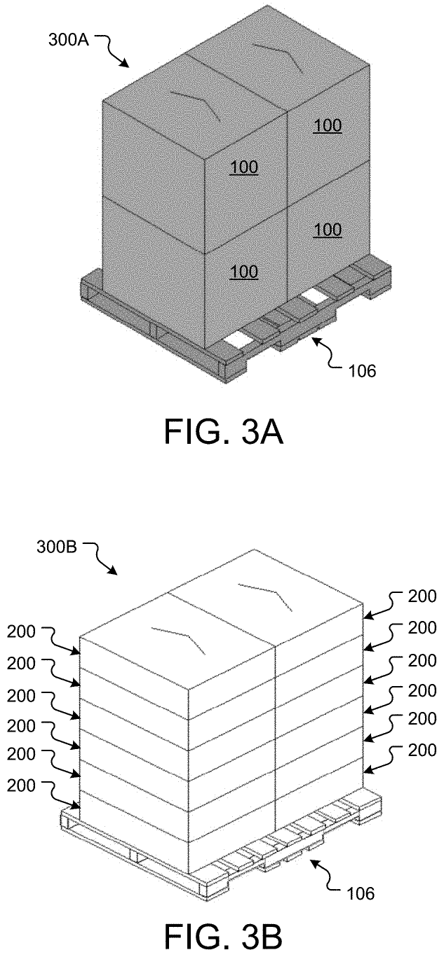

FIGS. 3A-3B show various schematic transport configurations of the reusable package 100 and compact package 200 in accordance with examples of the present disclosure. FIG. 3A shows a schematic perspective view of an expanded state of multiple reusable packages 100 stacked adjacent one another on a pallet 106. As shown in FIG. 3A, the reusable package 100 may correspond to a reusable package 100 in the expanded state (e.g., with the sidewall support structure 112 in an unfolded state, etc.). In some examples, each of the reusable package 100 may contain at least one product 124, insert 115, thermoformed insert 120, and/or the like. The reusable package 100 may be designed such that one reusable package 100 may support another reusable package 100, even when each of the reusable packages 100 is fully loaded (e.g., with a product 124, an insert 115, and one or more thermoformed inserts 120). In some examples, each reusable package 100 may be configured to carry and/or support at least 100 pounds in weight. In one example, each reusable package 100 (e.g., in the expanded state) may carry 130 pounds, or more, of material. Additionally or alternatively, each reusable package 100 (e.g., in the expanded state) may support 130 pounds, or more. FIG. 3A shows a first stacked configuration 300A of four reusable packages 100 on a pallet 106 comprising a first row having two reusable package 100 disposed therein and a second row stacked on top of the first row, the second row having two additional reusable packages 100 disposed therein. In some examples, each stack may comprise a reusable package 100 stacked directly over and on top of the reusable package 100.

FIG. 3B shows a schematic perspective view of a compact state of multiple reusable compact package 200 stacked adjacent one another on a pallet 106 in accordance with examples of the present disclosure. As illustrated in FIG. 3B, the compact package 200 takes up less than half of the space of the reusable package 100 in the expanded state. For instance, the second stacked configuration 300B includes six rows of two compact packages 200 whereas the first stacked configuration 300A only includes two rows of two compact packages 200. In the same overall volume, the second stacked configuration 300B is able to hold three times the number of reusable package 100 in the compact package 200 state than the reusable package 100 in the expanded state shown in FIG. 3A. In some examples, the compact package 200 may take up about one third of the volume of the reusable package 100 in the expanded state. In some examples, the second stacked configuration 300B may be returned to a manufacturer to be reused (e.g., used as the reusable package 100 for other products and/or devices.

The exemplary systems and methods of this disclosure have been described in relation to packaging and/or shipping containers. However, to avoid unnecessarily obscuring the present disclosure, the preceding description omits a number of known structures and devices. This omission is not to be construed as a limitation of the scope of the claimed disclosure. Specific details are set forth to provide an understanding of the present disclosure. It should, however, be appreciated that the present disclosure may be practiced in a variety of ways beyond the specific detail set forth herein.

A number of variations and modifications of the disclosure can be used. It would be possible to provide for some features of the disclosure without providing others.

References in the specification to “one embodiment,” “an embodiment,” “an example embodiment,” “some embodiments,” etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in conjunction with one embodiment, it is submitted that the description of such feature, structure, or characteristic may apply to any other embodiment unless so stated and/or except as will be readily apparent to one skilled in the art from the description. The present disclosure, in various embodiments, configurations, and aspects, includes components, methods, processes, systems and/or apparatus substantially as depicted and described herein, including various embodiments, subcombinations, and subsets thereof. Those of skill in the art will understand how to make and use the systems and methods disclosed herein after understanding the present disclosure. The present disclosure, in various embodiments, configurations, and aspects, includes providing devices and processes in the absence of items not depicted and/or described herein or in various embodiments, configurations, or aspects hereof, including in the absence of such items as may have been used in previous devices or processes, e.g., for improving performance, achieving ease, and/or reducing cost of implementation.

The foregoing discussion of the disclosure has been presented for purposes of illustration and description. The foregoing is not intended to limit the disclosure to the form or forms disclosed herein. In the foregoing Detailed Description for example, various features of the disclosure are grouped together in one or more embodiments, configurations, or aspects for the purpose of streamlining the disclosure. The features of the embodiments, configurations, or aspects of the disclosure may be combined in alternate embodiments, configurations, or aspects other than those discussed above. This method of disclosure is not to be interpreted as reflecting an intention that the claimed disclosure requires more features than are expressly recited in each claim. Rather, as the following claims reflect, inventive aspects lie in less than all features of a single foregoing disclosed embodiment, configuration, or aspect. Thus, the following claims are hereby incorporated into this Detailed Description, with each claim standing on its own as a separate preferred embodiment of the disclosure.

Moreover, though the description of the disclosure has included description of one or more embodiments, configurations, or aspects and certain variations and modifications, other variations, combinations, and modifications are within the scope of the disclosure, e.g., as may be within the skill and knowledge of those in the art, after understanding the present disclosure. It is intended to obtain rights, which include alternative embodiments, configurations, or aspects to the extent permitted, including alternate, interchangeable and/or equivalent structures, functions, ranges, or steps to those claimed, whether or not such alternate, interchangeable and/or equivalent structures, functions, ranges, or steps are disclosed herein, and without intending to publicly dedicate any patentable subject matter.

Exemplary aspects are directed to a reusable package, comprising: a base having an area and a plurality of sides forming a periphery of the area; a lid; and a sidewall support structure disposed between the base and the lid, comprising: a first panel extending a first height and a first width along a first plane, the first width extending from a first side edge of the first panel to a second side edge of the first panel, the first height extending from a first lower edge to a first upper edge; a second panel extending a second height and a second width along a second plane, the second width extending from a first side edge of the second panel to a second side edge of the second panel, the second height extending from a second lower edge to a second upper edge; a third panel extending a third height and a third width along a third plane, the third width extending from a first side edge of the third panel to a second side edge of the third panel, the third height extending from a third lower edge to a third upper edge, wherein a first fold crease is disposed in the third panel between the first side edge of the third panel and the second side edge of the third panel; and a fourth panel extending a fourth height and a fourth width along a fourth plane, the fourth width extending from a first side edge of the fourth panel to a second side edge of the fourth panel, the fourth height extending from a fourth lower edge to a fourth upper edge, wherein a second fold crease is disposed in the fourth panel between the first side edge of the fourth panel and the second side edge of the fourth panel; wherein the sidewall support structure is moveable between an unfolded state and a folded state, wherein, in the unfolded state, the first panel is arranged adjacent a first side of the plurality of sides at the periphery of the area, the second panel is arranged adjacent a second side of the plurality of sides at the periphery of the area, the third panel is arranged adjacent a third side of the plurality of sides at the periphery of the area, and the fourth panel is arranged adjacent a fourth side of the plurality of sides at the periphery of the area, and wherein, in the folded state, the third panel is folded along the first fold crease such that the first fold crease is offset from the third side of the plurality of sides toward a center of the area and the fourth panel is folded along the second fold crease such that the second fold crease is offset from the fourth side of the plurality of sides toward the center of the area.

Any one or more of the above aspects include wherein, in the unfolded state, the first lower edge, the second lower edge, the third lower edge, and the fourth lower edge are coupled to the base and the first upper edge, the second upper edge, the third upper edge, and the fourth upper edge are coupled to the lid, wherein the lid is offset from the base by the first height, and wherein the first plane, the second plane, the third plane, and the fourth plane are arranged perpendicular to the base. Any one or more of the above aspects include wherein, in the folded state, the first fold crease and the second fold crease are adjacent one another and disposed between the first panel and the second panel. Any one or more of the above aspects include wherein, in the folded state, the first panel is arranged parallel to the base and the second panel is arranged parallel to the lid, and wherein the base is disposed in contact with the lid. Any one or more of the above aspects include wherein, in the folded state, the first panel is arranged adjacent the base and the second panel is arranged adjacent the lid. Any one or more of the above aspects include wherein the lid, the base, and the sidewall support structure are each made from recycled material. Any one or more of the above aspects include wherein the lid, the base, and the sidewall support structure are each made from recyclable material. Any one or more of the above aspects further comprising: at least one thermoformed plastic insert sized to fit within the periphery of the area of the base. Any one or more of the above aspects include wherein the at least one thermoformed plastic insert is completely made from post-consumer recycled materials. Any one or more of the above aspects include wherein the at least one thermoformed plastic is a high-density polyethylene (HDPE). Any one or more of the above aspects include wherein the HDPE is opaque and colored at least one of dark grey and black. Any one or more of the above aspects include Any one or more of the above aspects include wherein, in the unfolded state, the reusable package has a first volume, wherein, in the folded state, the reusable package has a second volume, and wherein the second volume is at least one quarter of the first volume.

Exemplary aspects are directed to a reusable package kit, comprising: a base having an area and a plurality of sides forming a periphery of the area; a lid; and a sidewall support structure configured to be disposed between the base and the lid, comprising: a first panel extending a first height and a first width along a first plane, the first width extending from a first side edge of the first panel to a second side edge of the first panel, the first height extending from a first lower edge to a first upper edge; a second panel extending a second height and a second width along a second plane, the second width extending from a first side edge of the second panel to a second side edge of the second panel, the second height extending from a second lower edge to a second upper edge; a third panel extending a third height and a third width along a third plane, the third width extending from a first side edge of the third panel to a second side edge of the third panel, the third height extending from a third lower edge to a third upper edge, wherein a first fold crease is disposed in the third panel between the first side edge of the third panel and the second side edge of the third panel; and a fourth panel extending a fourth height and a fourth width along a fourth plane, the fourth width extending from a first side edge of the fourth panel to a second side edge of the fourth panel, the fourth height extending from a fourth lower edge to a fourth upper edge, wherein a second fold crease is disposed in the fourth panel between the first side edge of the fourth panel and the second side edge of the fourth panel; wherein the sidewall support structure is moveable between an unfolded state and a folded state, wherein, in the unfolded state, the first panel is capable of being arranged adjacent a first side of the plurality of sides at the periphery of the area, the second panel is capable of being arranged adjacent a second side of the plurality of sides at the periphery of the area, the third panel is capable of being arranged adjacent a third side of the plurality of sides at the periphery of the area, and the fourth panel is capable of being arranged adjacent a fourth side of the plurality of sides at the periphery of the area, and wherein, in the folded state, the third panel is capable of being folded along the first fold crease such that the first fold crease is offset from the third side of the plurality of sides toward a center of the area and the fourth panel is capable of being folded along the second fold crease such that the second fold crease is offset from the fourth side of the plurality of sides toward the center of the area.

Any one or more of the above aspects/embodiments as substantially disclosed herein.

Any one or more of the aspects/embodiments as substantially disclosed herein optionally in combination with any one or more other aspects/embodiments as substantially disclosed herein.

One or means adapted to perform any one or more of the above aspects/embodiments as substantially disclosed herein.

Any one or more of the features disclosed herein.

Any one or more of the features as substantially disclosed herein.

Any one or more of the features as substantially disclosed herein in combination with any one or more other features as substantially disclosed herein.

Any one of the aspects/features/embodiments in combination with any one or more other aspects/features/embodiments.

Use of any one or more of the aspects or features as disclosed herein.

It is to be appreciated that any feature described herein can be claimed in combination with any other feature(s) as described herein, regardless of whether the features come from the same described embodiment.

As used herein, the singular forms “a,” “an,” and “the” are intended to include the plural forms as well, unless the context clearly indicates otherwise. It will be further understood that the terms “include,” “including,” “includes,” “comprise,” “comprises,” and/or “comprising,” when used in this specification, specify the presence of stated features, integers, steps, operations, elements, and/or components, but do not preclude the presence or addition of one or more other features, integers, steps, operations, elements, components, and/or groups thereof. The term “and/or” includes any and all combinations of one or more of the associated listed items.

The term “a” or “an” entity refers to one or more of that entity. As such, the terms “a” (or “an”), “one or more,” and “at least one” can be used interchangeably herein. It is also to be noted that the terms “comprising,” “including,” and “having” can be used interchangeably.

The phrases “at least one,” “one or more,” “or,” and “and/or” are open-ended expressions that are both conjunctive and disjunctive in operation. For example, each of the expressions “at least one of A, B and C,” “at least one of A, B, or C,” “one or more of A, B, and C,” “one or more of A, B, or C,” and “A, B, and/or C” means A alone, B alone, C alone, A and B together, A and C together, B and C together, or A, B, and C together. When each one of A, B, and C in the above expressions refers to an element, such as X, Y, and Z, or a class of elements, such as X₁-Xₙ, Y₁-Yₘ, and Z₁-Zₒ, the phrase is intended to refer to a single element selected from X, Y, and Z, a combination of elements selected from the same class (e.g., X₁ and X₂) as well as a combination of elements selected from two or more classes (e.g., Y₁ and Zₒ).

Unless otherwise defined, all terms (including technical and scientific terms) used herein have the same meaning as commonly understood by one of ordinary skill in the art to which this disclosure belongs. It will be further understood that terms, such as those defined in commonly used dictionaries, should be interpreted as having a meaning that is consistent with their meaning in the context of the relevant art and this disclosure.

It should be understood that every maximum numerical limitation given throughout this disclosure is deemed to include each and every lower numerical limitation as an alternative, as if such lower numerical limitations were expressly written herein. Every minimum numerical limitation given throughout this disclosure is deemed to include each and every higher numerical limitation as an alternative, as if such higher numerical limitations were expressly written herein. Every numerical range given throughout this disclosure is deemed to include each and every narrower numerical range that falls within such broader numerical range, as if such narrower numerical ranges were all expressly written herein.

What is claimed is:

1. A reusable package, comprising:
a base having an area and a plurality of sides forming a periphery of the area;
a lid; and
a sidewall support structure disposed between the base and the lid, comprising:
a first panel extending a first height and a first width along a first plane, the first width extending from a first side edge of the first panel to a second side edge of the first panel, the first height extending from a first lower edge to a first upper edge;
a second panel extending a second height and a second width along a second plane, the second width extending from a first side edge of the second panel to a second side edge of the second panel, the second height extending from a second lower edge to a second upper edge;
a third panel extending a third height and a third width along a third plane, the third width extending from a first side edge of the third panel to a second side edge of the third panel, the third height extending from a third lower edge to a third upper edge, wherein a first fold crease is disposed in the third panel between the first side edge of the third panel and the second side edge of the third panel; and
a fourth panel extending a fourth height and a fourth width along a fourth plane, the fourth width extending from a first side edge of the fourth panel to a second side edge of the fourth panel, the fourth height extending from a fourth lower edge to a fourth upper edge, wherein a second fold crease is disposed in the fourth panel between the first side edge of the fourth panel and the second side edge of the fourth panel;
wherein the sidewall support structure is moveable between an unfolded state and a folded state, wherein, in the unfolded state, the first panel is arranged adjacent a first side of the plurality of sides at the periphery of the area, the second panel is arranged adjacent a second side of the plurality of sides at the periphery of the area, the third panel is arranged adjacent a third side of the plurality of sides at the periphery of the area, and the fourth panel is arranged adjacent a fourth side of the plurality of sides at the periphery of the area, and wherein, in the folded state, the third panel is folded along the first fold crease such that the first fold crease is offset from the third side of the plurality of sides toward a center of the area and the fourth panel is folded along the second fold crease such that the second fold crease is offset from the fourth side of the plurality of sides toward the center of the area.

2. The reusable package of claim 1, wherein, in the unfolded state, the first lower edge, the second lower edge, the third lower edge, and the fourth lower edge are coupled to the base and the first upper edge, the second upper edge, the third upper edge, and the fourth upper edge are coupled to the lid, wherein the lid is offset from the base by the first height, and wherein the first plane, the second plane, the third plane, and the fourth plane are arranged perpendicular to the base.

3. The reusable package of claim 1, wherein, in the folded state, the first fold crease and the second fold crease are adjacent one another and disposed between the first panel and the second panel.

4. The reusable package of claim 3, wherein, in the folded state, the first panel is arranged parallel to the base and the second panel is arranged parallel to the lid, and wherein the base is disposed in contact with the lid.

5. The reusable package of claim 4, wherein, in the folded state, the first panel is arranged adjacent the base and the second panel is arranged adjacent the lid.

6. The reusable package of claim 5, wherein the lid, the base, and the sidewall support structure are each made from recycled material.

7. The reusable package of claim 6, wherein the lid, the base, and the sidewall support structure are each made from recyclable material.

8. The reusable package of claim 1, further comprising:
at least one thermoformed plastic insert sized to fit within the periphery of the area of the base.

9. The reusable package of claim 8, wherein the at least one thermoformed plastic insert is completely made from post-consumer recycled materials.

10. The reusable package of claim 9, wherein the at least one thermoformed plastic is a high-density polyethylene (HDPE).

11. The reusable package of claim 10, wherein the HDPE is opaque and colored at least one of dark grey and black.

12. The reusable package of claim 1, wherein, in the unfolded state, the reusable package has a first volume, wherein, in the folded state, the reusable package has a second volume, and wherein the second volume is at least one quarter of the first volume.
